(19) United States
(12) Patent Application Publication
(10) Pub. No.: US 2007/0240041 A1
(43) Pub. Date: Oct. 11, 2007

(54) Methods and apparatus for generating an aggregated cascading style sheet

(76) Inventor: Larry Pearson, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/398,948

(22) Filed: Apr. 5, 2006

(51) Int. Cl. G06F 15/00

(52) U.S. Cl. 715/522; 715/523

(57) ABSTRACT

Methods and apparatus of generating an aggregated cascading style sheet (CSS) for display of a web page are disclosed. An example method includes receiving a first cascading style sheet (CSS) including a first element name related to the display of web page content. A second CSS including a second element name related to the display of web page content is also received. The first CSS and the second CSS are electronically combined into an aggregated CSS

### FIELD OF THE DISCLOSURE

This disclosure relates generally to portal web pages, and, more particularly, to methods and apparatus of generating an aggregated cascading style sheet (CSS) for display of a web page.

### BACKGROUND

Web portals are websites on the World Wide Web that provide functionality to their visitors. Frequently, portals are designed to use distributed applications, different numbers and types of middleware, and/or hardware to provide information and/or services from a number of different sources. In addition, some business portals are designed to facilitate collaboration among users.

Portlets are the building blocks of portals. Portlets are small, self contained applications that can provide static content or dynamic information. Multiple portlets can be rendered within a single portal page. Depending on varying factors, portlets can be built which provide single-click access to back end systems or even provide personalized information without any specific user interaction.

One or more portlets can be hosted both within a particular portal via software tools such as Java Portlet Specification JSR168 and/or remotely through the Web Services for Remote Portlets (WSRP) specifications. These specifications allow portal website providers and/or their partners and suppliers to build a portlet that provides specific functionality and deploy it on a partner's portal with very little work on the partner's behalf. This arrangement has the potential of drastically reducing time to market as a content provider does not have to establish the entirety of its own portal, but instead use one or more existing portlet(s) to add content to an existing portal.

In web based computing, cascading style sheets (CSS) are a style sheet language used to describe the presentation of content written in a markup language. Cascading style sheets are used by both the authors and readers of web pages to define colors, fonts, layout, and other aspects of content presentation. The CSS specifications are designed primarily to enable the separation of content structure (written in html or a similar markup language) from content presentation (written in CSS).

CSS can be used with XML to allow such structured documents to be rendered with full stylistic control over layout, typography, color, and so forth in any suitable user agent or web browser. Use of CSS allows presentation information for an entire website or collection of pages to reside in one place. Such presentation information may be updated quickly and easily if a style sheet is imported. Different users can have different style sheets: large print and text readers for example. The document code is reduced in size and complexity, since it does not need to contain any presentational markup. CSS has a simple syntax, and uses a number of English keywords to specify the names of various style properties. In general, web site designers create and deploy cascading style sheets that cover a wide range of web pages.

To support the multiple styles present in different web pages available to portal users, a portal provider includes elements from the cascading style sheets of each of the content providers/partner who provide content via the portal. Each style to be supported inside of the cascading style sheets is provided a unique name. To avoid name conflicts, care is taken so that each partner has a unique name describing the style information. Such information includes the name of each style and uniquely named styles in advance of using them. Manually editing cascading style sheets and checking for name conflicts is time consuming and prone to error. Each time one of the content providers/partners modifies their CSS requires a lengthy process to include the changes in all the portal provider's style sheets.

This problem becomes more pronounced when a portal provider wants to include partner portlets in the portal. To support the inclusion of partner portlets with the look and feel of the partner portlet on the portal requires that the portal provider include the partner's CSS elements in the style sheets of the portal. Such inclusion results in greater danger of conflicting styles and names. The problem grows larger as other partners also have portlets on the portal which support the unique look and feel of each portlet.

### BRIEF DESCRIPTION OF DRAWINGS

FIG. 1 is an example web based environment to integrate content from different providers for a portal web page;

FIGS. 2A-2C are example web pages produced using an example method of automatically combining cascading style sheets using different portlets accessible via the portal web page of FIG. 1.

FIG. 3 is a block diagram of an example system to automatically generate combined cascading style sheets.

FIG. 4 is a flow diagram representative of machine readable instructions which may be executed to generate combined cascading style sheets from different portlets.

FIG. 5 is a block diagram of an example computing device which may execute the instructions represented by FIG. 4 to implement the example system in FIG. 3.

### DETAILED DESCRIPTION

In general an example method for generating an aggregated cascading style sheet for displaying a web page is disclosed. A first cascading style sheet (CSS) including a first element name related to the display of web page content is received. A second CSS including a second element name related to display of web page content is received. The first CSS and the second CSS are electronically combined into an aggregated CSS.

Another example system has a content aggregator to combine two or more content files for a web page. The system also has a CSS aggregator to combine two or more CSS associated with the two or more content files.

A further example cascading style sheet (CSS) aggregator is disclosed. The example CSS aggregator has an interface to receive a first CSS having at least one element name and a second CSS having at least one element name. An element comparer is provided to determine whether a first element name in the first CSS is duplicated by a second element name in the second CSS. An element translator is provided to change at least one of the first and second element names that has been duplicated.

Another example apparatus has a portal aggregator to combine two or more content files from one or more portlet providers. A cascading style sheet (CSS) aggregator is provided to combine two or more CSS files relating to at least one of the two or more content files from the one or more portlet providers.

A further example apparatus has a cascading style sheet (CSS) aggregator to compare two or more CSS files to determine if any element names in the two or more CSS files are duplicated and to change the name of at least one of any part of duplicated names.

An example article of manufacture storing machine readable instructions which, when executed, cause a machine to receive a first cascading style sheet (CSS) including a first element name related to the display of web page content. The example instructions also receive a second CSS including a second element name related to the display of web page content. The instructions electronically combine the first CSS and the second CSS into an aggregated CSS.

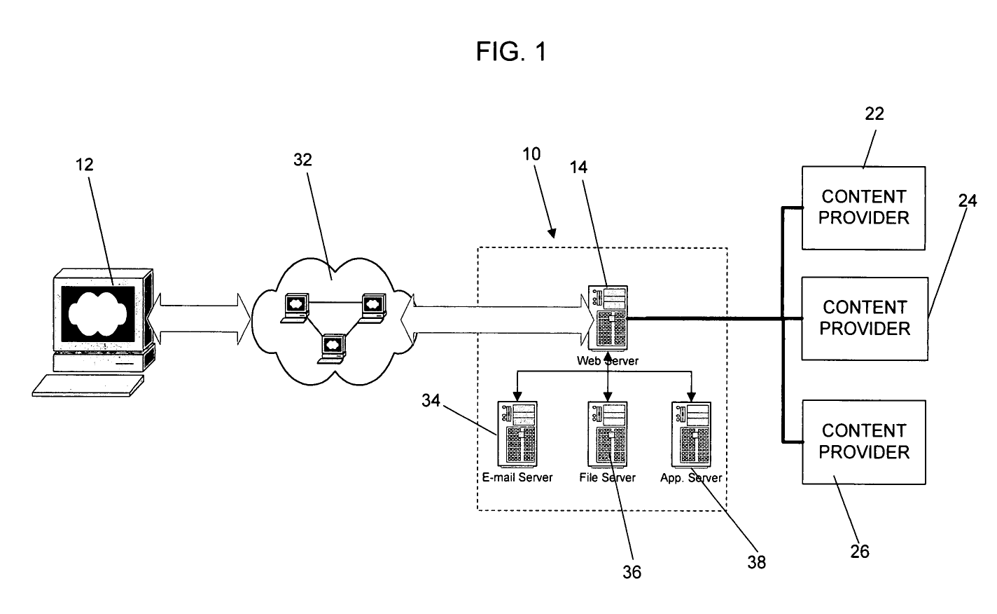

FIG. 1 is a block diagram of an example portal provider 10 to provide individualized content to a web browser device 12. Those of ordinary skill in the art will appreciate that the web browser device 12 may be a personal computer, a lap top computer, a PDA, a cell phone or any other similar device which can run web browser software such as Microsoft Explorer. The portal provider 10 includes a web server 14. The web server 14 receives content from different content providers 22-26 and provides a web page or pages to the web browser device 12. The webpage of the illustrated example has a unique style and contains content provided by the portal provider 10 and/or the content providers 22-26. The web server 14 is accessible via the Internet 32. It is to be understood, that there can be multiple web browser devices accessing the web server 14. Further, multiple users can each have individual accounts which are accessible via an individualized portal web page or pages provided by the web server 14. The web server 14 may also generate a generic home page associated with the portal provider 10 to provide information for first time and/or one time visitors to the portal.

In this example, the content provider 22 provides weather data presented in a first visual style to the portal provider 10. The weather data is provided at least in part via a portlet from the content provider 22. In this example, the content provider 24 provides phone service related features presented in a second visual style to the portal provider 10. The phone service related features are provided at least in part via a portlet from the content provider 24. In this example, the content provider 26 provides information regarding wireless communications products and services presented in a third visual style to the portal provider 10. The communications product and services information are provided at least in part via a portlet from the content provider 26. Of course it should be understood that these are merely illustrative examples, and different content may be provided from the same or other content providers (news, market data, other products and services etc.).

The portal web page generated by the web server 14 contains individualized information user of a device 12 represents the webpage using the unique style of the portal provider 10 and the style(s) of any assortment of portlets used by the portal provider 10. The portlets may contain fixed content and/or content selected by an individual user or predicted as useful by the portal and/or portlets contained in the portal based on past interaction with the web server 14.

In the illustrated example, the web server 14 is coupled to different servers which are responsible for storing individualized data relating to each user of the portal 10. For example, the portal server 14 may be coupled to an e-mail server 34, a file server 36 and an application server 38. The e-mail server 34 stores e-mail messages relating to users of the portal provider 10 and allows e-mail data specific to a given user to be displayed on the portal web page generated for that user. The file server 36 in this example provides a certain amount of storage for files which are accessible by an individual user via the portal web page. The application server 38 provide one or more software applications to be executed by the user via the portal web page generated for the user by the web server 14.

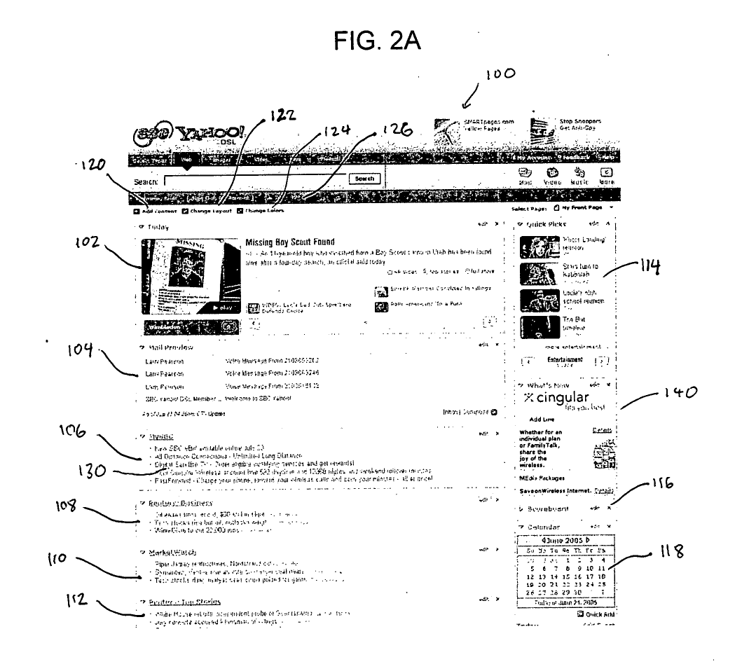

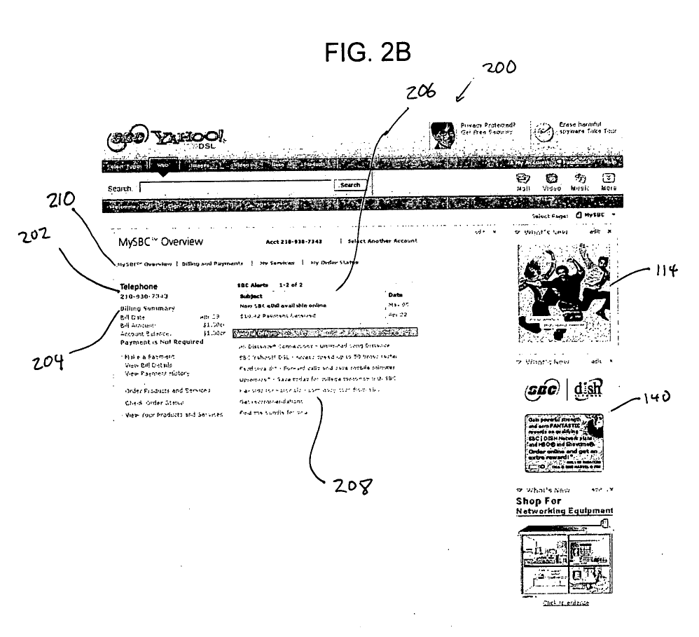

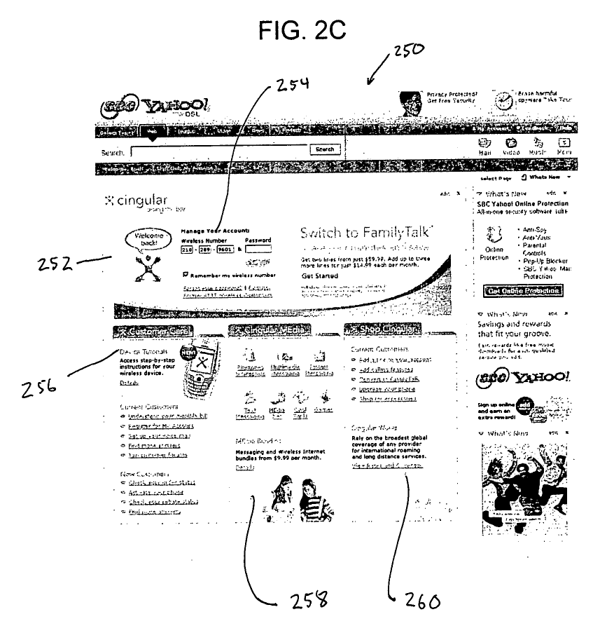

FIG. 2A shows an example portal web page 100 provided by the web server 14 of the portal provider 10 in FIG. 1. The example portal web page 100 has a framework style which is identifiable to the portal provider 10 and set up by a cascading style sheet (CSS) for consistency with other web pages which are associated with the portal provider 10. The framework style is a combination of elements such as text style, text layout, background, border, margin padding, colors, and page layout. Of course persons of ordinary skill in the art will recognize there are many other elements to a design of a web page which may be described with a CSS. The portal web page 100 of the illustrated example includes individualized content which is provided to the user by the portal server 14 and third party content providers such as providers 22-26 in FIG. 1. Thus, certain style elements provided by the CSS are generic for each user web page. Specific content is provided by the portal server 14 or other servers such as the servers 34, 36 and 38 in FIG. 1 and/or by the portlets provided by the content providers 22-26 in FIG. 1. For example, the portal web page 100 in FIG. 2A includes a headline news area 102, an e-mail area 104, a phone service area 106, a business news area 108, a market area 110 and a news feed area 112. Other areas include an entertainment area 114, a sports scoreboard area 116 and a calendar area 1 18. Any of these areas may be populated by a portlet associated with the portal provider 10 or with any of the content providers 20-26.

Additional content may be added by a user to further customize the portal web page 100 via control buttons including for example an add content button 120, a change layout button 122 and/or a change colors button 124. The information in the areas described above may or may not individualized when provided by the portal server 14. For example, the content to the e-mail area 104 is supplied via the e-mail server 34 in FIG. I and is user specific. Content such as a weather data heading 126 may be supplied by a content provider such as content provider 22 for insertion in the web page 100. Further, content in different areas of the web page 100 may be supplied by separate content providers via portlets with their own unique presentation style as defined in their corresponding CSS. Additional portlets which are made available by the same and/or different content providers may also be selected via the add content button 120. Portlets are made accessible by a variety of ways, for example, via hyperlinks, icons, or even separate areas on the portal web page.

An example of a hyperlink to content supplied by a content provider via a portlet is in the phone service area 106 which allows access to content provided by one of the content providers (e.g. content provider 24) in FIG. 1. The phone service area 106 includes a number of hyperlinks 130 which allow the user to display different content on the web page 100 from the portlet provided by the content provider 24 in FIG. 1. In this example, the content provider 24 is also a vendor of phone services available to individuals who access the web page provided by the portal server 14.

Portlets may be used to customize the design style of different areas of the web page 100 to give such areas a unique look and feel distinct from the basic look and feel of the web page 100 associated with the portal provider 10. For example, a portlet which is directly displayed such as an advertising area 140 which relates to wireless service may be provided with a unique look and feel. The portlet which supports the advertising area 140 is provided by a content provider (e.g., content provider 26) in FIG. 1. The style of the advertising area 140 is based on CSS data provided by the portlet of the content provider 26 and, thus, has a different style then that of the portal web page 100.

FIG. 2B shows an example web page 200 generated by the portal server 114 as a result of selecting one of the links 140 in the phone service area 106 in FIG. 2A. In the example web page 200, the general style is the same as the web page 100 shown in FIG. 2A. However, a new expanded phone service portlet area 202 has been displayed in the area previously occupied by the headline news area 102, e-mail area 104, phone service area 106, business news area 108, market area 110 and newsfeed area 112 in the example portal web page 100 of FIG. 2A. Other areas such as the entertainment area 114 and the advertising area 140 remain the same as in FIG. 2A and FIG. 2B. The content of the portlet generated area 202 is formatted based on the style of CSS data associated with the portlet offered by the provider 24. As will be explained further, the CSS data of the content provider 24 is embedded in a dynamic CSS generated by the portal server 14 to display the web page 200 to ensure the styles for the content in each area are consistent.

The content in the portlet generated area 202 is provided by the corresponding content provider (in this example, content provider 24 in FIG. 1). The content includes generic information provided to numerous phone service subscribers as well as user specific information. This content is stored by the content provider 24 in FIG. 1 in, for example, data servers and sent to the web server 14 of the portal provider as will be explained below. In the illustrated example, the content in the portlet generated area 202 includes a billing summary 204 which is specific to the user. An alerts section 206 displays messages by the portlet provider for all users. The links section 208 provides additional links to further content offered via a portlet from the content provider 24. Additional presentations which are offered via the portlet from the content provider 26 in the portlet generated area 202 may be selected from tab controls 210.

FIG. 2C shows another example web page 250 which is generated by the example web server 14 in FIG. 1. The web page 250 includes a portlet generated area 252 which replaces the headline news area 102, e-mail area 104, phone service area 106, business news area 108, market area 110 and newsfeed area 112 in the example portal web page 100 in FIG. 2A. The generated area 252 displays content provided by the content provider 26 in FIG. 1 which, in this example, is a wireless communications provider which places advertising on the portal web page. The web page 250 is displayed as a result of selecting a link in the wireless communications advertising area 140 in FIG. 1. As shown in FIG. 2C, the web page 250 retains the overall style of other web pages associated with the portal provider 10 with the exception of certain areas which have styles determined by portlets provided by content providers such as the portlet generated area 252 and the wireless communications advertising area 140.

The portlet generated area 252 obtains its content from a content provider (e.g., content provider 26) in FIG. 1. The content in the area 252 is defined by a style according to a CSS file which is provided by the content provider 26 to the portal web server 14. More individualized information may be accessed if user identification information is obtained (e.g., via a sign-in area 254). Other areas in FIG. 2C include a customer care area 256, a media information area 258 and a shopping area 260 which display product and/or service information and/or contain links to further web pages which could be provided independently of the portal or to further web areas which appear within the portal web page 250. Those of ordinary skill in the art will recognize that many different arrangements and presentation styles may be used for content in portlet areas such as the portlet area 252.

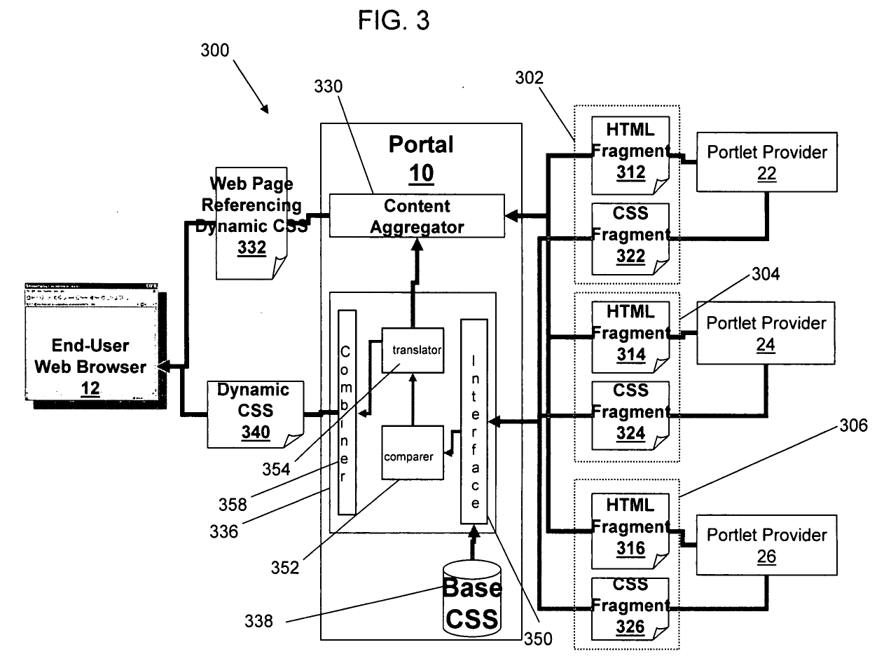

FIG. 3 illustrates an example system 300 to provide dynamic creation of Cascading Style Sheets (CSS) for a web page generated by the portal provider 10 and including portlets offered by content providers 22-26. The example system 300 includes the portal 10 which has an interface to receive content from the content providers 22, 24 and 26 which each have a portlet 302, 304 and 306 respectively. In this example, each of the portlets 302, 304 and 306 which provide different style presentation for their content. The portal web pages combine the look and feel style of the portal provider 10 and the look and feel style designed by the content providers 22-26 via their portlets 302, 304 and 306. As explained above, multiple portlets may be accessed via the portal provider 10 depending on arrangements made between the owner of the portal provider 10 and one or more different content providers.

Each portlet 302, 304 and 306 each include base content data in a mark up language (e.g., an html file fragment 312, 314 and 316). The content of file fragments 312, 314 and 316 contains the content provided by the corresponding portlets 302, 304 and 306. Those of ordinary skill in the art will understand that other types of appropriate mark up languages may be used for the content file including for example, XML or a complete file rather than a file fragment may be used for the base content data. Each portlet 302, 304 and 306 also include respective cascading style sheet (CSS) data such as CSS fragments 322, 324 and 326 respectively. The CSS fragments 322, 324 and 326 define the look and feel style to be applied when the content in the corresponding html file fragments 312, 314 and 316 are presented. Those of ordinary skill in the art will understand that the CSS data may be either in fragments or complete CSS files.

In the illustrated example, a cascading style sheet (CSS) or CSS file may be used with a web page document such as an html file and has a series of instructions often referred to as statements. A CSS fragment also contains statements but is not a complete CSS file. A statement identifies the element in content data such as the html file fragments 312, 314 and 316 or complete html files that it affects and contains instructions how to present these elements. Example elements include paragraphs, links, list items etc. located in the html file. A statement includes a selector which identifies page elements and a declaration which is an instruction on how the selected element(s) identified by the computer selector should be drawn. A declaration can contain any number of properties, (i.e., the individual pieces of style to be applied to the selected element).

In this example, the portal 10 includes a content aggregator 330 which combines the html file fragments 312, 314 and 316 into an overall web page file 332. It will be understood by those of ordinary skill in the art that different numbers of html file fragments or other documents in other markup languages may be used to produce the overall document. The web page file 332 in this example is an html document which contains calls to cascading style sheets in order to maintain the look and feel of the portal web page and any portlets displayed on that page.

The content aggregator 330 of the illustrated example is linked to a CSS aggregator 336 to determine style names for the content documents. The CSS aggregator 336 assembles the CSS file fragments 322, 324 and 326 received from the portlet providers 22, 24 and 26. The portal server 14 also provides a base CSS 338 to the CSS aggregator 336. The CSS aggregator 336 combines the base CSS 338 with the CSS fragments 322, 324 and 326 provided by each of the portlet providers 22, 24 and 26. The CSS aggregator 336 provides the translation mapping to enable the content aggregator 330 to automatically translate the corresponding element names from the CSS files in the html file fragments 312, 314 and 316 providing unique element names prevents conflicts and ensures consistent presentation of the differing styles outlined in the CSS fragments 322, 324 and 326 and the base CSS 338.

The portlet aggregator 330 produces the aggregated web page file 332 which references a dynamic aggregated CSS file 340. The dynamic CSS file 340 is created by the CSS aggregator 336 from the CSS fragments 322, 324 and 326 and the base CSS 338. Both the aggregated web file 332 and the aggregated CSS 340 include translated client names. The end user web page which, for example, may be the portal web page 200 shown in FIG. 2A, is created from the base web page file 332 (which is an html document in the illustrated example) and the dynamic CSS file 340 referenced by the base web page document 332. Using the system 300, the dynamic CSS file 340 of the portal website does not need to be entirely altered to accommodate changes in the styles of the content providers. Modifications may be made by the content providers in their portlet resulting in a new CSS file being sent to the CSS aggregator 336. The CSS aggregator 336 then translates any elements conflicting with existing elements into unique element names to automatically create a modified dynamic CSS file 340 which prevents any conflicts and eliminating the necessity of rewriting the entire CSS for the web page. The system 300 may be used to generate any number of web pages which are stored on the web server 14 in FIG. 1 for transmission to web browsing devices.

The CSS aggregator 336 includes an interface 350 to receive the CSS data such as the CSS fragments 322, 324 and 326 from external sources such as the content providers 22, 24 and 26 and internally such as the base CSS 338. The CSS aggregator 336 also includes an element comparer 352 that compares all of the element names of the base CSS 338 and the CSS fragments 322, 324 and 326 to identify any redundancies or name conflicts. The CSS aggregator 336 also has an element translator 354 which translates any duplicated element names used in the CSS fragments 322, 324 and 326 and/or the base CSS 338 to ensure uniqueness with respect to each other. The portlet aggregator 330 receives the unique element names and corresponding non-unique element names from the element translator 354 and replaces the references to the non-unique element names in the content files to produce the base web page document 332 with only unique element names. After any duplicate element names are translated, a CSS combiner 358 combines the CSS files and fragments received into a single CSS file such as the dynamic CSS file 340.

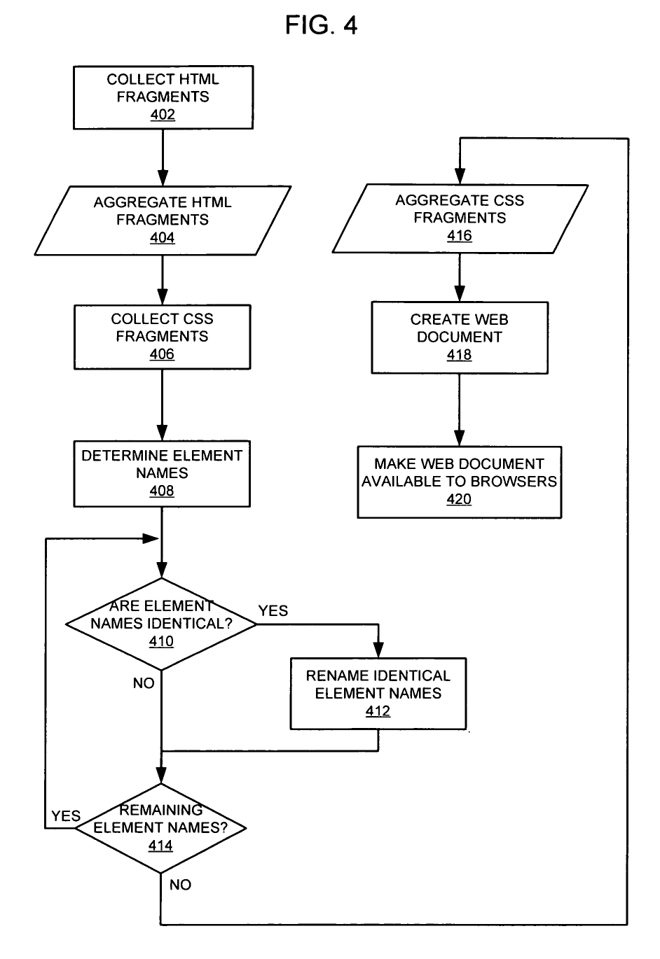

FIG. 4 is a flow diagram 400 representative of machine readable instructions which may be executed to implement the example apparatus 300 of FIG. 3 and/or to create a web page for the end user web browser 12 shown in FIG. 1. As shown in FIG. 4, the system 300 first collects all html files or fragments from each accessed content provider (block 402). The html files and/or fragments are aggregated into a single content document such as a combined html document (block 404). The system then collects CSS files and/or fragments from the accessed content providers (block 406). The CSS files and/or fragments are then analyzed to identify all of the element names in the files and/or fragments (block 408). In block 410, each element name from each CSS file and/or fragment is compared with every other element name in the CSS file and/or fragment and the base CSS to determine if any element names are duplicates or one another (block 412). If a duplicate name is detected, the duplicate name is given a new unique name (block 414). The system then determines whether there are any remaining element names (block 414). If an element name remains which has not been checked (block 414) control returns to block 410. Thus, the element name check process in block 410 is repeated for every element name in any of the CSS files and/or fragments or the base CSS. After block 410 is performed for all of the element names, the modified CSS files and/or fragments are then combined with the base CSS for the portal (block 416) to create a dynamic combined CSS. The new element names are then changed in the parts of the web content document by the portal aggregator (block 418). The single content document is linked to the dynamic combined CSS (block 420), and made available to web browser devices (block 422). The process outlined in FIG. 4 is repeated any time a CSS file and/or fragment is changed.

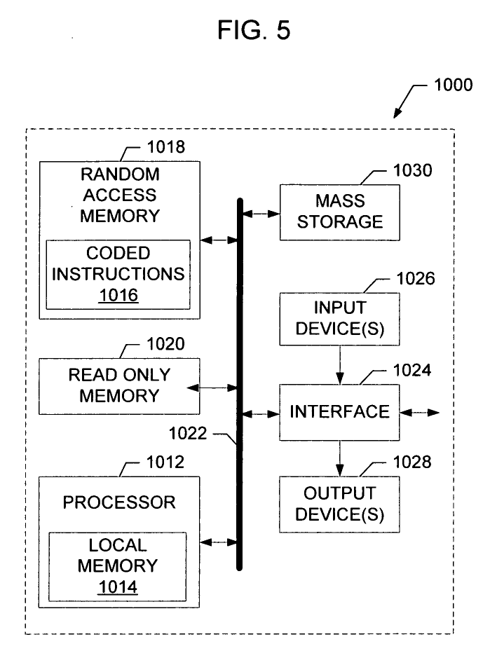

FIG. 5 is a schematic diagram of an example processor platform 1000 which may be used to execute the example machine readable instructions illustrated in FIG. 4 to implement the system of FIG. 3. For example, the processor platform 1000 can be implemented by one or more general purpose microprocessors, microcontrollers, etc. The processor platform 1000 of the example includes the processor 1012 that is a general purpose programmable processor. The processor 1012 executes coded instructions present in a memory 1020 of the processor 1012. The processor 1012 may be any type of processing unit, such as a microprocessor. The processor 1012 includes a local memory 1014. The processor 1012 may execute, among other things, the example machine readable instructions illustrated in FIG. 4 to produce the web pages shown in FIGS. 2A-2C.

The processor 1012 is in communication with the main memory including a read only memory (ROM) 1020 and/or a RAM 1018 via a bus 1022. The RAM 1018 may be implemented by Synchronous Dynamic Random Access Memory (SDRAM), Dynamic DRAM, and/or any other type of RAM device. The ROM 1020 may be implemented by flash memory and/or any other desired type of memory device. Access to the memory space 1020 and 1018 is typically controlled by a memory controller (not shown) in a conventional manner. The RAM 1018 may be used by the processor 1012 to implement the memory 1020, and/or to store coded instructions 1016 that can be executed to implement the example machine readable instructions illustrated in FIGS. 1-11.

The processor platform 1000 also includes a conventional interface circuit 1024. The interface circuit 1024 may be implemented by any type of well known interface standard, such as an external memory interface, serial port, general purpose input/output, etc. One or more input devices 1026 are connected to the interface circuit 1024. One or more output devices 1028 are also connected to the interface circuit 1024. Additional permanent storage may be offered via a mass storage device 1030 which may be a hard drive. In the illustrated example, a telephone or telephony equipment may be part of the input devices 1026.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e- mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Further, while the forgoing describes systems and processes for providing support to customers of a telecommunications provider, persons of ordinary skill in the art will recognize that the forgoing systems and processes may be used to provide support to customers of any type of business. For example, the forgoing systems and processes may be used to provide support to customers of a credit card distributor, an electronics manufacturer, a cable television and/or internet provider, a satellite television and/or internet provider, a computer manufacturer or retailer, a cellular phone service provider, a bank, a securities brokerage business, an internet retailer, etc.

This patent contemplate examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of generating an aggregated cascading style sheet (CSS) for display of a web page, the method comprising:
receiving a first CSS including a first element name related to the display of web page content;
receiving a second CSS including a second element name related to display of web page content; and
electronically combining the first CSS and the second CSS into an aggregated CSS.

2. A method as defined in claim 1, further comprising combining a base CSS with the first and second CSS to create an aggregated CSS.

3. A method as defined in claim 1, further comprising:
comparing the first CSS to the second CSS to determine if the element name in the second CSS is identical to the element name in the first CSS; and
where the element name in the second CSS is identical to the element name in the first CSS, changing the element name in the second CSS.

4. A method as defined in claim 3 further comprising:
receiving a first content for the web page with the first element name of the first CSS, wherein the first CSS effects at least one display characteristic of the first content;
receiving a second content for the web page with the second element name of the second CSS, wherein the second CSS effects at least one display characteristic of the second content; and
combining the first content and the second content into a combined file.

5. A method as defined in claim 4 wherein the first and second contents are written in html.

6. A method as defined in claim 5 further comprising changing the second element name of the second CSS in the second content if the second element name in the second CSS is identical to the first element name in the first CSS.

7. A method as defined in claim I further comprising accepting a modified first CSS and changing the aggregated CSS based on the modified first CSS.

8. A system comprising:
a content aggregator to combine two or more content files for a web page; and
a cascading style sheet (CSS) aggregator to combine two or more CSS associated with the two or more content files.

9. A system as defined in claim 8, further comprising a web page server to transmit the combination of the two or more content files and the combination of the two or more CSS to a web browsing device.

10. A system as defined in claim 9 where at least one of the two or more content files and at least one of the two or more CSS are provided by a content provider.

11. A system as defined in claim 10, wherein the two or more content files are written in html.

12. A cascading style sheet (CSS) aggregator comprising:
an interface to receive a first CSS having at least one element name and a second CSS having at least one element name;
an element comparer to determine whether a first element name in the first CSS is duplicated by a second element name in the second CSS; and
an element translator to change at least one of the first and second element names that has been duplicated.

13. A CSS aggregator as defined in claim 12, further comprising a CSS combiner to combine the two or more CSS into a single CSS and to transmit the combined CSS to a web browsing device.

14. A CSS aggregator as defined in claim 12, further comprising an interface to receive a base CSS.

15. An apparatus comprising:
a portal aggregator to combine two or more content files from one or more portlet providers; and
a cascading style sheet (CSS) aggregator to combine two or more CSS files relating to at least one of the two or more content files from the one or more portlet providers.

16. An apparatus comprising a cascading style sheet (CSS) aggregator to compare two or more CSS files to determine if any element names in the two or more CSS files are duplicated and to change the name of at least one of any part of duplicated names.

17. The apparatus of claim 16 further comprising a portal aggregator coupled to the CSS aggregator to change the name of at least one of any duplicated names in a content file.

18. The apparatus of claim 17 further comprising:
a web server to store the content document, the content document made available for a browser device via a communication device; and
wherein the portal aggregator combines the two or more CSS files to create a dynamic CSS file and associates the content document with the dynamic CSS file.

19. The apparatus of claim 18 further comprising a base CSS file with style information related to a portal provider, the base CSS file being combined with the two or more CSS files by the CSS aggregator.

20. The apparatus of claim 19 wherein the content document is written in html.

21. An article of manufacture storing machine readable instructions which, when executed, cause a machine to:
receive a first cascading style sheet (CSS) including a first element name related to the display of web page content;
receive a second CSS including a second element name related to the display of web page content; and
electronically combine the first CSS and the second CSS into an aggregated CSS.

22. The article of manufacture storing machine readable instructions of claim 21 which, when executed, cause a machine to:
compare the first CSS to the second CSS to determine if the second element name in the second CSS is identical to the first element name in the first CSS; and
where the second element name in the second CSS is identical to the first element name in the first CSS, change the second element name in the second CSS.

23. The article of manufacture storing machine readable instructions of claim 22 which, when executed, cause a machine to:
receive a first content for the web page with the first element name of the first CSS, wherein the first CSS effects at least one display characteristic of the first content;
receive a second content for the web page with the second element name of the second CSS, wherein the second CSS effects at least one display characteristic of the second content; and
combine the first content and the second content into a combined file.

24. The article of manufacture storing machine readable instructions of claim 23 which, when executed cause a machine to change the second element name of the second CSS in the second content if the second element name in the second CSS is identical to the first element name in the first CSS.

25. The article of manufacture storing machine readable instructions of claim 21 which, when executed, cause a machine to accept a modified first CSS and change the aggregated CSS based on the modified first CSS.
